(19) United States
(12) Patent Application Publication
(10) Pub. No.: US 2008/0035577 A1
(43) Pub. Date: Feb. 14, 2008

(54) System and Method for Treatment of Industrial Wastewater

(75) Inventors: Edward Brook-Levinson, Petach Tikva (IL); Yevgenia Dorrokhotov, Herzliya (IL); David Gurevich, Ariel (IL)

Correspondence Address: BROWDY AND NEIMARK, P.L.L.C.;624 NINTH STREET, NW, SUITE 300, WASHINGTON, DC, 20001-5303, US

(73) Assignee: Uniqkleen-Wastewater Treatment Ltd., Migdal Ha'emek (IL)

(21) Appl. No.: 10/589,021

(22) PCT Filed: Feb. 10, 2005
(86) PCT No.: PCT/IL05/00172

§ 371 Date: Apr. 11, 2007

(30) Foreign Application Priority Data
Feb. 12, 2004 (IL) 160384

(51) Int. Cl. C02F 1/52; B01D 21/30; C02F 1/72; C02F 1/42

(52) U.S. Cl. 210/667; 210/137; 210/142; 210/170.08; 210/713; 210/722; 210/85; 210/90

(57) ABSTRACT

A system and method for treatment of wastewater containing heavy metals, oil products, detergents, phenols, dyes, complexions, complexionates, etc. are described. The system includes a static mixer configured for continuous mixing the wastewater supplied thereto with desired reagents; a feeder of a magnetic powder; at least one coagulator apparatus; at least one oxidizer apparatus; at least one flocculant apparatus; and a magnetic separator configured for applying a magnetic field across an effluent of the wastewater and separating the magnetic sludge from the water. The method includes introducing powder of a ferromagnetic particulate material into the wastewater; adjusting a value of a pH of the wastewater, to form a liquid effluent of the wastewater having an adjusted value of the pH; oxidizing the wastewater having an adjusted value of the pH; flocculating the wastewater, to form flakes of magnetic sludge in water; and separating the magnetic sludge from the water.

### FIELD OF THE INVENTION

This invention relates to a technique for the treatment of contaminated wastewater, and more particularly to a method and system for the treatment of industrial wastewater with complex contamination containing organic and inorganic compounds, heavy metals, organic substances, detergents, suspended solids, emulsions, etc.

### BACKGROUND OF THE INVENTION

A significant amount of research and development has been undertaken in recent years towards environmental clean-up operations, and in particular to the purification of ground water and treatment of wastewater containing suspended solids and emulsified and dissolved impurities of different nature. A variety of techniques have been used in the prior art to destroy and/or remove from wastewater various contaminating and toxic materials, such as oil and oil products; heavy metals; organic substances; detergents; suspended solids; emulsions; substances which produce color, taste and odor; and harmful suspended materials.

These techniques usually include two main stages of the wastewater treatment (see, for example, U.S. Pat. Nos. 4,049,545 to Horvath; 4,758,353 to Spence, et al.; 4,882,069 to Pohoreski; 5,256,304 to Meyer, et. al.; 5,882,513 to Stevenson; 5,266,210 to McLaughlin; 5,308,499 to Dixon; and 5,639,379 to Stogner).

The first stage comprises removal of suspended solids, emulsified and partly dissolved impurities by their precipitation using various combinations of organic and inorganic coagulants, organic flocculants and polymers. In turn, the precipitation stage is divided into several sub-stages. Each sub-stage can employ various precipitating coagulants and chemicals (see, for example U.S. Pat. No. 5,266,210) along with various flocculants, polymers and detergents (see, for example, U.S. Pat. No. 5,308,499), and can be completed by the removal of the formed sludge.

The second stage comprises purification and fine polishing of dissolved impurities, which cannot be removed by precipitation and coagulation at the first stage. Various methods can be employed for this purpose, depending on the nature of the impurities to be removed. In particular, organic substances dissolved in the water can be removed by using various methods of organic substance destruction or adsorption.

For example, U.S. Pat. No. 5,639,379 describes a process for removing color and odor from wastewater effluent of textile production that is contaminated from dye complexes. The process requires treatment of the effluent with alkali metal permanganate, followed by treatment with hydrogen peroxide, followed by treatment of a primary coagulant as a flocculation initiator (together with pH control so that the pH is basic), followed by treatment with a water soluble polymer, and followed by separating precipitated flocculated material from the effluent to obtain a clear effluent free of color and odor.

U.S. Pat. No. 4,882,069 describes a method for the treatment of sewage or other impure water. The method includes adding, to the sewage or other impure water three chemicals, such as an inorganic coagulant, an anionic polymer and a cationic polymer. The patent teaches adding these three chemicals individually but no more than two chemicals premixed together. The added chemicals are mixed with the sewage or other impure water, with the proviso that the inorganic coagulant, either alone or with the anionic polymer or the cationic polymer, cannot be added last; and the anionic polymer and the cationic polymer cannot be intimately mixed and added together.

U.S. Pat. No. 4,049,545 describes a method of treating domestic, commercial or industrial waste water which includes the steps of mixing the waste water with a coagulant aid so as to bring the pH of the mixture to within a range of about 9.0-10.5, and thereafter adding precipitating agents in at least two successive steps so as to lower the pH of the mixture by about one unit for each step and thereby precipitate solids therefrom until the mixture is approximately neutral. After the addition of each precipitating agent, the precipitated solids are separated from the waste water effluent before the next succeeding precipitating agent is added. Preferably two such successive precipitation steps are performed, after which the resultant waste water effluent is treated with an oxidizing and disinfecting agent, filtered, and then treated with a further oxidizing and disinfecting agent to minimize the B.O.D. level.

The described prior art techniques suffer from various disadvantages. One of the main drawbacks of these techniques is related to the fact that the treated wastewater cannot be purified from organic impurities and heavy metals within one process stage. The techniques require numerous stages of removing the precipitates. Moreover, these techniques suffer from the incomplete oxidation of the dissolved organic impurities and the incomplete removal of intermediate oxidation products from the wastewater. Furthermore, the oil products removed from the wastewater cannot be utilized. Likewise, the described techniques do not provide the required level of the wastewater cleaning for wide range of oil products and detergents.

### SUMMARY OF THE INVENTION

Despite the prior art in the area of water decontamination techniques, there is still a need in the art for, and it would be useful to have, a novel method and system for treatment of industrial wastewater which is effective for treatment of high toxic industrial wastewater from heavy metals, oil products, detergents, phenols, dyes, complexions and complexionates (i.e., its compounds with metals ions) as well as other dissolved, emulsified and/or suspended impurities.

It would be advantageous to have a technique which has high efficiency of the treatment and deep level of purification.

It would further be useful to have a technique which is able to reduce consumption of polymer flocculants.

It would still be advantageous to increase the precipitate formation rate, reduce the time and increase the efficiency of removal of the non-soluble precipitates from the water, when compared to the prior art techniques.

It would also be advantageous to provide a higher level of removal of intermediate products of oxidizing destruction of the organic substances.

It would still be advantageous to provide separation of the oil products from the other impurities for further utilization of the oil in the regular applications.

The present invention satisfies the aforementioned need by providing a novel method for treatment of industrial wastewater with complex contamination.

According to one embodiment of the invention, the wastewater that can be contaminated, inter alia, by heavy metals, oil products, detergents, phenols, dyes, complexions, and complexionates and other dissolved, emulsified and/or suspended impurities is firstly treated by introducing powder of a ferromagnetic material into the wastewater.

The method also includes adjusting pH of the wastewater, to form a liquid effluent having an adjusted value of the pH. Accordingly, the adjusting of the pH of the wastewater is carried out by introducing a coagulant agent into the wastewater. According to one embodiment of the invention, the adjusting of the pH of the wastewater is carried out by introducing firstly a basic coagulant, e.g., Ca(OH)₂. The preferable values of pH of the wastewater for beginning the coagulation are between 9 and 14. The sludge can coagulate on magnetic particles playing a role of nuclei for suspension growth.

It should be noted that the introduction of the ferromagnetic powder and the basic coagulant can be carried out either simultaneously or individually. In the latter case, according to one example, the ferromagnetic powder is introduced before the basic coagulant, while, according to another example, the ferromagnetic powder is introduced after the basic coagulant.

The method further includes oxidizing the effluent of the wastewater obtained after adjusting the value of the pH. According to one embodiment, after the adjusting of the value of the pH with a basic coagulant, the oxidizing is carried out by introducing a first oxidizer (e.g., NaClO), which is efficient at high pH, in the effluent. In this step, the oxidation products are mainly organic acids. The sludge particles formed during the process serve as a catalyst.

Then, the adjusting of the pH of the wastewater is carried out by introducing an acidic coagulant, e.g., FeSO₄, into the wastewater for reducing the pH to the values in the range of about 6 to 9, thereby coagulating the metals remaining from the treatment with the basic coagulant.

According to one embodiment of the invention the method includes further oxidizing the liquid effluent of the wastewater obtained after the adjusting of the value of the pH with an acidic coagulant. For this purpose, a second oxidizer, which is mainly efficient in the acidic media, is added to the effluent. This oxidant continues the oxidation of the organic contaminants by converting them into the simple substances, e.g., CO₂ and H₂O.

According to this embodiment of the invention, the method further includes flocculating the wastewater after the adjusting of the value of the pH with second oxidizer. The flocculating of the wastewater can be carried out by an individual introducing of cationic and anionic flocculants into the wastewater. As a result of the flocculating, a layer of the flocculant(s) is(are) formed on the surface of the coagulated particles. It should be understood that in certain circumstances, the flocculants can be only one type, either cationic or anionic. The cationic and anionic flocculants make the magnetic sludge become hydrophobic. As a result of the flocculation stage, the flakes of magnetic sludge are formed in the water.

When required, the effluent formed after the flocculating can be further oxidized by repeat introduction of the second oxidizer that completes the oxidation of the dissolved organic matter by using the surface of the newly formed sludge as a catalyst for the oxidation process and the capacity of the sludge to adsorb both the oxidizing impurities, intermediate products of its oxidation and the excessive oxidizer itself and the products of its decomposition.

The method further includes separating the sludge from the water, preferably by magnetic separation.

The method can include dewatering the sludge obtained after the separation from the water. Thus, the dewatered sludge can be packaged and stored. In turn, the water obtained after separation from the sludge can be discharged into a sewage network or returned to any technological processes.

In order to reduce the volume of the secondary wastes and the consumption of the reagents, including the ferromagnetic reagent with simultaneous preserving or improving the quality of the wastewater treatment, the sludge, after the separation from the water, can be recycled. Thus, according to yet a further embodiment of the invention, the sludge can partially be returned into the coagulation and flocculation zones where it can be used as a ferromagnetic reagent material.

It should be noted that all the above-described steps of the method can generally be implemented in “on-line” mode in a wastewater stream flowing at high velocity.

The method of the present invention can be applied to treating the wastewater in electronic industry (e.g., PCB production), power stations, chemical, petrochemical, metallurgic, metal treatment, pulp and paper mill, textile, food, pharmaceutical and other industries, including complete recycling of the water.

The method for treating industrial wastewater of the present invention has many of the advantages of the techniques mentioned theretofore, while simultaneously overcoming some of the disadvantages normally associated therewith.

The method for treating industrial wastewater of the present invention can provide deep purification of highly toxic industrial wastewater with complex and variable composition from the impurities of different nature, such as suspended solids, liquid emulsified, colloidal and dissolved in water organic and inorganic substances.

The method for treating industrial wastewater of the present invention can provide removal of the impurities with high efficiency which results in an extremely high standard of the effluent water, approaching to the standards for the drinking water.

The method for treating industrial wastewater of the present invention can provide effective coagulation and flocculation of the impurities in wide concentration range of detergents and emulsified oil products. These substances normally reduce the efficiency of coagulation when using the prior art methods for wastewater treatment.

The method for treating industrial wastewater of the present invention can provide the secondary waste sludge (combining magnetic susceptibility, hydrophobic properties and catalytic activity), which can, at least partially, be utilized. The sludge can be compactly packaged and suitable for long time safety storage.

The method of the present invention offers optimal combination of precipitation, catalytic oxidation, and ion-exchange adsorption. In other words, each stage of the method prepares optimal conditions for the execution of the next stage.

The aforementioned need is also satisfied by providing a system for treating industrial wastewater. The system includes a static mixer configured for continuous mixing the wastewater supplied thereto with desired reagents, such as a ferromagnetic particulate material, at least one coagulation agent, at least one oxidizer and at least one flocculant. The system also includes a feeder of the ferromagnetic particulate material to the static mixer. Likewise, the system includes at least one coagulator apparatus coupled to the static mixer, and configured for preparation of a coagulation agent and supplying thereof to the static mixer. Moreover, the system includes at least one oxidizer apparatus coupled to the static mixer and configured for supplying an oxidizer thereto. Further, the system includes at least one flocculant apparatus coupled to the static mixer and configured for supplying a flocculent agent thereto to form flakes of the magnetic sludge in water. The system also includes a magnetic separator configured for receiving the wastewater flowing downwardly from the static mixer and configured for applying a magnetic field across an effluent of the wastewater, thereby to separate the magnetic sludge from the water.

When required, the system can comprise a sludge suspension container downstream of the magnetic separator. The system can yet comprise a dryer downstream of the sludge suspension container that communicates with the static mixer for partial returning the magnetic sludge thereto. Moreover, the system can comprise a first circulation pump for supplying the wastewater to the static mixer. Likewise, the system can comprise a second circulation pump for supplying the magnetic sludge to the static mixer.

The system also comprises a control unit configured for providing a control of the system. For this purpose the system can comprise at least one sensor configured for generation a signal indicating at least a pressure or flow level. The system can comprise at least one water quality sensor adapted to indicate a water quality.

In summary, according to one broad aspect of the present invention, there is provided a method for treating industrial wastewater, comprising:

(a) introducing powder of a ferromagnetic particulate material into the wastewater in an amount effective to provide magnetic susceptibility to sludge;

(b) adjusting a value of a pH of the wastewater, to form a liquid effluent of the wastewater having a predetermined value of the pH;

(c) oxidizing the wastewater having an adjusted value of the pH;

(d) flocculating the wastewater, to form flakes of the magnetic sludge in water; and

(e) separating the magnetic sludge from the water.

According to another broad aspect of the present invention, there is provided a system for treating industrial wastewater, comprising:
a static mixer configured for continuous mixing the wastewater supplied thereto with desired reagents;
a feeder of a magnetic powder configured for providing a ferromagnetic particulate material to said static mixer;
at least one coagulator apparatus coupled to said static mixer, and configured for preparation of a coagulation agent and supplying thereof to said static mixer;
at least one oxidizer apparatus coupled to said static mixer and configured for supplying an oxidizer thereto;
at least one flocculant apparatus coupled to said static mixer and configured for supplying a flocculant agent thereto to form flakes of the magnetic sludge in water; and

a magnetic separator configured for receiving the wastewater flowing downwardly from said static mixer and configured for applying a magnetic field across an effluent of the wastewater, thereby to separate the magnetic sludge from the water

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, preferred embodiments will now be described, by way of non-limiting example only, with reference to the accompanying drawings, in which:

FIG. 1 is a schematic flowchart representing a multi-stage method for treatment of industrial wastewater, according to one embodiment of the present invention; and

FIG. 2 is a schematic representation of a system for treating industrial wastewater, according to one embodiment of the preset invention.

### DETAILED DESCRIPTION OF SPECIFIC EMBODIMENTS

The principles and operation of the method and system according to the present invention may be better understood with reference to the drawing. It is understood that this drawing are given for illustrative purposes only and is not meant to be limiting.

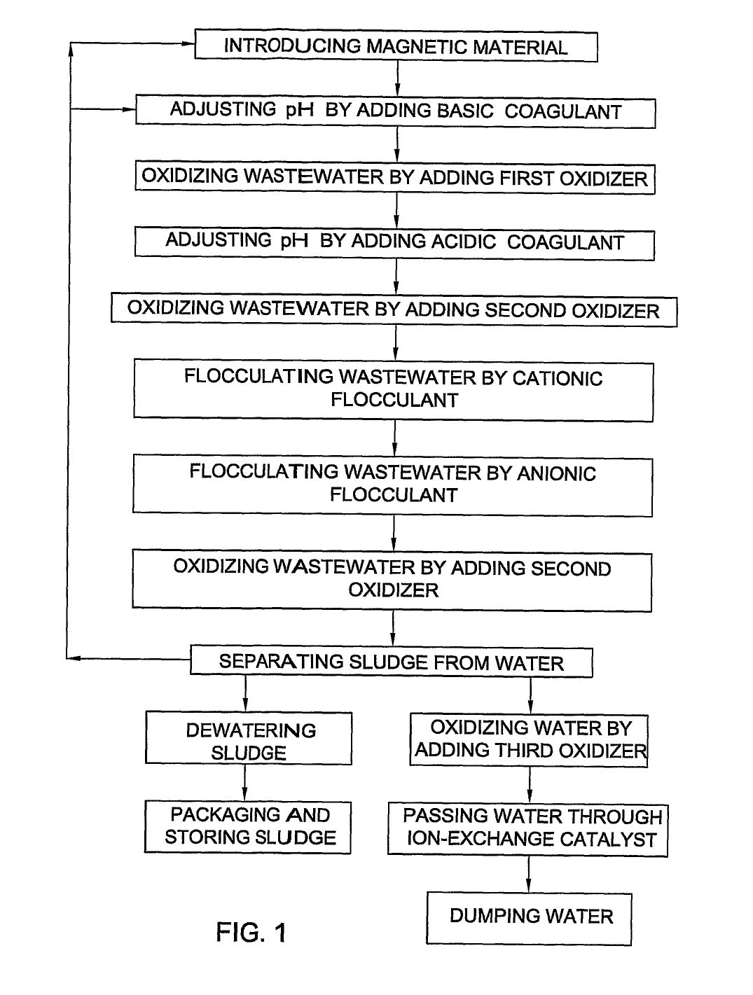

Referring to FIG. 1, a schematic flowchart representing a multi-stage method for treatment of industrial wastewater is illustrated, according to one embodiment of the present invention. According to the invention, the method includes introducing powder of a ferromagnetic particulate material into the wastewater. The purpose of the addition of the ferromagnetic powder is manifold. More specifically, the particles of the ferromagnetic powder, inter alia, can serve as nuclei for a further sludge formation. Furthermore, the particles can provide the formed sludge with magnetic susceptibility sufficient for further magnetic separation of the sludge from the water. Additionally, the particles can reduce the consumption of polymer flocculants, which can be introduced in the wastewater in the later stages of the treatment. Moreover, the magnetic sludge, obtained magnetic properties owing to the particles, can be recycled as magnetic material in further processing of new portions of wastewater. Likewise, the magnetic properties of the sludge allow using a magnetic field for suspending the magnetic sludge in the water, thereby to provide a prolonged contact between the wastewater and the sludge surface that, in this case, serves as a catalyst in the organic impurities oxidation process.

Examples of the ferromagnetic particulate materials in the form of ferromagnetic powder include, but are not limited to, the sludge resulting from the neutralization of the waste solutions from the production of anticorrosion coatings, ferrites of heavy metals, e.g., zinc ferrite obtained during neutralization of the waste resulting from etching and washing solutions in the chemical coating and galvanizing production, magnetite (Fe₃O₄), gamma-hematite (gamma-Fe₂O₃), Barium ferrite (BaFe₂O₄), etc.

A particle size of the ferromagnetic particulate material can, for example, be in the range of about 1 to 100 microns. The dose of the ferromagnetic material introduced into the wastewater can be in the range of about 5 mass % to 30 mass % of the entire dose of the other inorganic coagulants introduced into the wastewater, as will be described herebelow. It was found by the inventors, that the dose less than 5 mass % does not provide magnetic susceptibility to the sludge sufficient for its magnetic separation from the water. On the other hand, the dose higher than mass 30%, inter alia, can lead to an incomplete coagulation of suspended solids as well as emulsified and dissolved impurities.

The method also includes adjusting pH of the wastewater, to form a liquid effluent having an adjusted value of the pH. Accordingly, the adjusting of the pH of the wastewater is carried out by introducing into the wastewater a coagulation agent. Thus, according to one embodiment of the invention, the adjusting of the pH of the wastewater is carried out by introducing firstly a basic coagulant. An example of the basic coagulant includes, but is not limited to, Ca(OH)₂. The preferable values of pH of the wastewater for beginning the coagulation are between 9 and 14. Such a range of the pH values is determined by the process efficiency. Thus, the value of pH less than 9 reduces the efficiency of the detergents and oil product treatments, while the value of pH greater than 14 can result in the elevated consumption of reagents and in lower efficiency of some heavy metals removal.

The sludge can coagulate on magnetic particles playing a role of nuclei for suspension growth. The result of this coagulation step is removal of heavy metals (Me) by providing insoluble metal hydroxide Me(OH)₂, to with: Me²⁺+20H⁻=Me(OH)₂, where the metals may, inter alia, be ions of Ni, Co, Cd, Hg, etc.

According to one embodiment, the introducing of the ferromagnetic powder and the basic coagulant in the wastewater is carried out individually. In this case, according to one example, the ferromagnetic powder is introduced before the basic coagulant (as shown in FIG. 1), while, according to another example, the ferromagnetic powder is introduced after the basic coagulant (not shown).

According to another embodiment of the invention, the ferromagnetic powder is introduced simultaneously with the basic coagulant (not shown).

Further, the method includes oxidizing the liquid effluent obtained after the adjusting of the value of the pH of the wastewater. According to one embodiment, the oxidizing of the effluent is carried out by introducing a first oxidizer in the wastewater, which is efficient at high pH. An example of the first oxidizer includes, but is not limited to, sodium hypo chlorite (NaClO). The oxidizing can decompose the organic substances dissolved in the wastewater. The oxidation products are mainly organic acids. It should be noted that the introducing of the first oxidizer results in the partial decomposition of the organic substances. Accordingly, the further decomposition can be completed at the later stage of the process.

The next step of the method, according to this embodiment of the invention, includes a further adjusting of the pH of the wastewater by introducing a coagulation agent capable to reduce the pH (e.g., an acidic coagulant) into the effluent obtained after the oxidizing with the first oxidizer. Examples of the acidic coagulant include, but are not limited to, FeSO₄, other salts of iron or aluminum. According to this embodiment of the invention, the introduction of the acidic coagulant into the wastewater results in reduction of the pH value of the wastewater, preferably to the pH value between 6 and 9. The lower limit of this range is related to the fact that the further reduction of the pH value can result in the dissolving of the deposited sludge. This step results in formation of insoluble metal hydroxide Me(OH)₂, to with: Me²⁺+20H⁻=Me(OH)₂, of the heavy metals (e.g., Zn²⁺, Cr³⁺, etc.) that were not precipitated at the first coagulation stage. At this stage of the process, the deposition of all heavy metals, which can be presented in the wastewater, is completed.

Thereafter, the process can include the step of oxidizing the wastewater by introducing a second oxidizer, which is mainly efficient in the acidic media. Examples of the second oxidizer include, but are not limited to, hydrogen peroxide (H₂O₂) and ozone (O₃). The second oxidizer further oxidizes the impurities dissolved in the wastewater. In particular, the second oxidizer can continue or even complete oxidation of the organic contaminants by converting them into simple substances, like CO₂ and H₂O.

Moreover, the process includes flocculating the wastewater. The flocculating of the wastewater can be carried out after the coagulation stage by an individual introducing of cationic and anionic flocculants into the wastewater. As a result of the flocculating, a layer of a flocculant is formed on the surface of the coagulated particles. It should be understood that at certain circumstances, the flocculants can be only one type, either cationic or anionic.

The order of the introduction of the cationic and anionic flocculants depends on the prevailing sign of the charge of the colloidal particles dispersed in the wastewater. Thus, when the prevailing charge of the colloids is negative, the cationic flocculant is added first, and vice versa, the anionic flocculant is added first when the prevailing charge of the colloids is positive. It should be noted that in those cases when a majority of the suspended particles (e.g., more then 5 mass %) do not form floccules larger than 10 mm in size, the flocculants with high cationic or anionic properties are used.

The introducing of cationic and anionic flocculants makes the magnetic sludge hydrophobic. As a result, of the flocculation stage, the flakes of magnetic sludge are formed in the water.

According to one embodiment of the invention, the second oxidizer, which is mainly efficient in the acidic media, can also be added to the wastewater after the step of the introducing of cationic and anionic flocculants.

It should be appreciated that the surface of the newly formed ferromagnetic sludge can serve as a catalyst of the oxidation processes. Likewise, the ferromagnetic sludge is capable to adsorb the oxidizing impurities, products of its oxidation and the excessive oxidizer itself as well as the products of its decomposition.

It should be appreciated that depending on the wastewater contamination, the second oxidizer can be added to the wastewater only one time after the introducing of an acidic coagulant into the wastewater, either before or after the introducing of cationic and anionic flocculants.

After the flocculating, the sludge formed during the treatment of the wastewater can be separated from the water. The fraction of this sludge usually does not exceed 1 volume % to 3 volume % of the treated water, it is hydrophobic, susceptible to spontaneous dewatering and stable with respect to discharging the contaminants into environment. The sludge can be floated, filtered, or precipitated under gravitation.

According to a preferable embodiment of the invention, the sludge formed during the treatment is separated from the water by applying a magnetic field across an effluent of the wastewater after the flocculating. The magnetic separation of the sludge from the water can be feasible owing to the magnetic properties of the sludge. For example, the magnetic filed having a strength greater than about 0.1 Tesla (1,000 Gauss) can be sufficient to provide the separation of the sludge having the floccules lesser than 10 mm in size from the water flowing with the linear velocity (flow rate) of about 100 m/hour. The magnetic separation can provide the highest effect, when compared to other known methods. The rate of the sludge separation from the water is high, because the linear velocity of the water in the process can be in the range of 100 m/h to 1000 m/h, that by several times exceeds the velocity of conventional mechanical filtration and flotation. Moreover, the magnetic separation can provide superior densification and dewatering of the sludge.

According to a further embodiment of the invention, when required, the process is supplemented with a further treatment of removal of the traces of organic, especially, toxic organic substances as well as heavy metal traces and ions, especially, toxic heavy metals, like Cd²⁺, Cr (VI), etc. In this case, a third oxidizer, which is even more active in the acidic medium than the second oxidizer can be added to the water after the introducing of cationic and anionic flocculants. Examples of the third oxidizer include, but are not limited to, hydrogen peroxide and ozone.

The water can be passed through an ion-exchange fiber material capable to adsorb simultaneously all the oxidizing impurities, intermediate products of its oxidation and the excessive oxidizer itself as well as the products of its decomposition. In this case, the oxidation of the impurities dissolved in the water can occur on the surface of the ion-exchange fiber material. Due to the adsorption, oxidation-reduction reactions can take place on the surface of such material, which cannot occur in the bulk wastewater because of the too high energy barrier. Therefore, the ion-exchange material in this case can work as a catalyst in the oxidation process for facilitating the oxidation-reduction reactions. At the same time, the ion-exchange material can effectively collect the ions of heavy metals.

In order to provide more complete removal of the intermediate organic products of the oxidation destruction, the water separated from the sludge can first be passed through an ion-exchange catalyst being in its neutral form, and thereafter can be passed through the ion-exchange catalyst, being in its basic form. Such a treatment can provide better purification of the water from organic acids which are formed on the surface of the catalyst, when it is in the neutral form. Thereafter, these organic acids can be removed from the water by means of the chemical adsorption on the catalyst surface, when it is in basic form. In this case, the organic acids are subjected to a further destruction, up to water and carbon dioxide. As a result of this treatment, the COD can be reduced to the standard of drinking water.

According to still a further embodiment of the invention, when required, the method of the present invention can include the stage of preliminary separating the oil products (not shown), implying a further utilization of the separated oil product. In this case, anionic and cationic flocculants are added to the water before the coagulation stage, i.e. before adding to the wastewater the first and second coagulants and first and second oxidizers. In particular, the cationic flocculant should preferably be added before the anionic flocculant, when the prevailing charge of the coalescing emulsion is a negative one, and vice versa, the anionic flocculant should preferably be added before the cationic flocculant, when the prevailing charge of the coalescing emulsion is positive. It should be appreciated that when the electrical potential of emulsion drops is low, the flocculants with high cationic and/or anionic properties should preferably be used. The oil product macro phase formed as a result of this treatment can be separated, for example, by flotation. Thereafter, the coagulation stage of the entire treatment process can be carried out, as described above.

According to yet a further embodiment of the invention, the method further includes dewatering the sludge obtained after the separation from the water. Thus, the dewatered sludge can be packaged and stored. In turn, the water obtained after separating from the sludge can be dumped into a sewage network or returned to any technological processes requiring water supply.

In order to reduce the volume of the secondary wastes and the consumption of the reagents, including the ferromagnetic reagent with simultaneous preserving or improving the quality of the wastewater treatment, the method includes recycling the sludge separated from the water. Thus, the sludge can partially be returned into the coagulation and flocculation zones where it can be used as a ferromagnetic reagent material.

After being delivered to the zone, these sludge particles can operate as the centers of nucleation, thereby promoting the nucleation process during the coagulation and flocculation, and thus reducing the demand in the magnetic reagent. Therefore, the final content of the impurities in the sludge can grow, while the efficiency of the impurities removal can be preserved at the same level or even be improved.

It should be appreciated that formed sludge exposes pronounced hydrophobic properties. Thus, its partial return to the coagulation zone can result in even more efficient adsorption of the organic and surfactant substances as well as coalescence of emulsified organic impurities (e.g. oil products), which, in turn, can improve the quality of the wastewater treatment. More specifically, the fraction of the recycled sludge (recycling coefficient) can be in the range of 10 mass % to 50 mass % of the total sludge mass. It was found by the inventors that the recycling coefficient is lower than 10 mass % of the total sludge mass, it does not lead to significant reduction of the reagent consumption and the facilitation of the coalescence of the emulsified organic impurities. On the other hand, when the recycling coefficient has a value which is greater than 50 mass % of the total sludge mass, it does not provide the magnetic susceptibility of the sludge sufficient for its magnetic separation from the water.

It should be appreciated that the partial recycling of the magnetic sludge can be provided both in continuous and periodical modes of the wastewater treatment. In the continuous mode, conventional magnetic separators can be used utilizing recycling of the sludge. While, in the periodical mode the sludge is not completely removed from a treatment system after completing the treatment process, in accordance with the present invention. Then, a new portion of the wastewater can be supplied to the treatment system, giving rise to the new cycle of the wastewater treatment, etc.

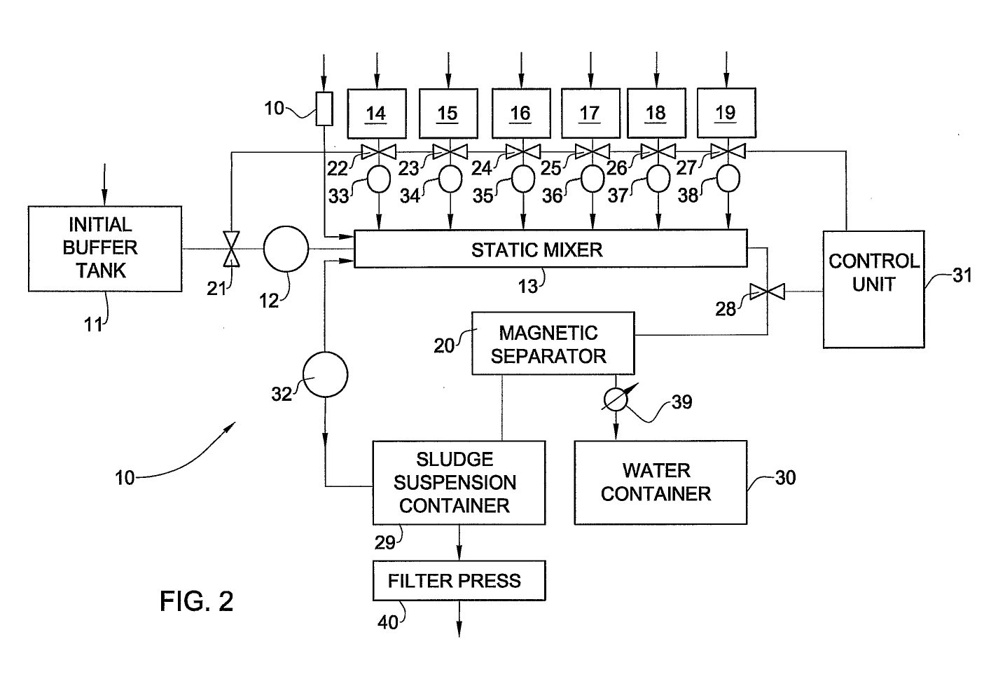

Referring to FIG. 2, a schematic representation of an exemplary system 1 for treating industrial wastewater is illustrated, wherein the flows of water and treatment components are illustrated by arrows. It should be noted that the blocks in FIG. 2 are intended as functional entities only, such that the functional relationships between the entities are shown, rather than any physical connections and/or physical relationships.

Wastewater is accumulated in an initial buffer tank 11 from which the wastewater is fed to a static mixer 13 configured for continuous mixing the wastewater with various reagents. According to one embodiment of the invention, the wastewater is supplied to the static mixer 13 by a first circulation pump 12. According to another embodiment, the wastewater flows into the static mixer 13 downwardly by gravity. The wastewater flow may be controlled by an inlet control valve 21 which may also include a pressure and/or flow sensor (not shown).

The system 1 includes a feeder 10 of a ferromagnetic powder to the static mixer 13 configured for providing a ferromagnetic particulate material thereto. The static mixer 13 can be coupled to at least one coagulator apparatus configured for preparation of a coagulation agent. According to the example shown in FIG. 2, the system includes two such apparatuses, i.e. a fist coagulation apparatus 14 and a second coagulator apparatus 15. The fist coagulator apparatus 14 is configured for the preparation of a basic coagulant, while the second coagulator apparatus 15 is configured for the preparation of an acidic coagulant. The basic and acidic coagulants can be supplied to the static mixer 13, for example, by means of dosing pumps 22 and 23, respectively. The supply of reagents for the preparation of the basic and acidic coagulants can be controlled by basic and acidic coagulant supply valves 22 and 23, respectively. The purpose of the basic and acidic coagulants and the required doses are described above in connection with the method of the present invention.

The static mixer 13 can be also coupled to at least one oxidizer apparatus configured for preparation of an oxidizer. According to the example shown in FIG. 2, the system includes two oxidizer apparatuses, i.e., a fist oxidizer apparatus 16 and a second oxidizer apparatus 17. The fist and the second oxidizer apparatuses 16 and 17 are configured for supplying the first and second oxidizers, in accordance with the foregoing method of the present invention. The supply of fist and the second oxidizers can be controlled by first and second oxidizer supply valves 24 and 25, respectively.

Moreover, the static mixer 13 can be coupled to at least one flocculant apparatus configured for preparation of a flocculant agent. According to the example shown in FIG. 2, the system includes two flocculant apparatuses, i.e. a fist coagulation apparatus 18 and a second coagulator apparatus 19. The fist flocculant apparatus 18 is configured for the preparation of a cationic flocculant, while the second flocculant apparatus 15 is configured for the preparation of an anionic flocculant, in accordance with the foregoing method of the present invention. The supply of the cationic and anionic flocculants can be controlled by cationic and anionic flocculant supply valves 26 and 27, respectively.

After the treatment in the static mixer 13, wastewater is supplied downwardly to a magnetic separator 20 coupled to the static mixer 13. The flow of wastewater between the magnetic separator 20 and the static mixer 13 can be controlled by a wastewater control valve 28. The magnetic separator 20 is a device configured to apply a magnetic field across an effluent of the wastewater provided by the static mixer 13 after the flocculation, and thereby to separate the magnetic sludge from the water.

The magnetic sludge provided by the magnetic separator 20 is supplied to a sludge suspension container 29 communicating with the static mixer 13. The sludge can partially be returned to the static mixer 13, where it can be used as a ferromagnetic reagent material provided additionally to the ferromagnetic particulate material provided by the feeder 10. The motive force to cause the sludge to flow to the static mixer 13 can, for example, be provided by a second circulation pump 32. When required, this sludge can be dewatered by a filter-press 40 arranged downstream of the sludge suspension container 29. After the dewatering, the sludge can be packed and stored.

In turn, the water provided by the magnetic separator 20 flows downwardly, for example, by gravity into a water container 30. The treated water can then be supplied from the water container 30 to any technological processes or can be dumped in a sewerage network (not shown).

The system 1 is controlled by a control unit 31. The control unit 31 is in communication with several conventional sensing and control devices including, but are not limited to, pressure and/or flow sensors, water quality sensors, wastewater control valves 21 and 28, the reagent supply valves 22-27, water meters, a service indicator (not shown), the pumps 12, 32-38, as well as other similar or suitable devices. Each may be a commercially available component. The pressure and/or flow sensors (not shown) can generate sensor signals for sending information to the control unit 31 to indicate flow and/or pressure levels, and can, for example, be arranged in the valves 21-28. The water quality sensors can be arranged at any desired location along the wastewater flow. For example, a water quality sensor 39 can be downstream of the magnetic separator 30. Thus, the water quality sensor 39 is included in the system 10 to indicate that treatment has been achieved or other quality parameters are met. Examples of the water quality sensor include turbidity meters, biosensors, biological sensors, and other similar, suitable, and conventional devices. The service indicator is an alarm/notification device that can be used to notify the user that service is needed for the system. Each of the exemplary sensing and control devices can be used to provide information to the controller unit to obtain the desired operation of the system. The control unit is configured to generate control signals for controlling, inter alia, flow and/or pressure levels by controlling, for example, the valves 21-28, pumps 12, 32-38, as well as other similar or suitable devices.

### EXAMPLES

The essence of the present invention can be better understood from the following non-limiting examples which are intended to illustrate the present invention and to teach a person of the art how to make and use the invention. These examples are not intended to limit the scope of the invention or its protection in any way.

### Example 1

Wastewater from a pond for a long-term conservation of toxic wastes of a regional center was treated in accordance with the method of the invention by the following way.

First, zinc ferrite powder was introduced into the wastewater taken from the neutralization process of waste etching solution used in the zinc coating process. Then, the wastewater was treated by basic coagulant (e.g., calcium hypo chlorite suspension) for adjusting the pH from its original value of 8.3 to the value of 10.5. After the primary coagulation stage, the wastewater was treated by acidic coagulant (e.g., aluminum sulfate) for adjusting the pH to the value of 7.5. The zinc ferrite fraction was set to 10 mass % of the total amount of calcium hypo chlorite and aluminum sulfate.

Further, an anionic flocculent was added based on poly acryl amide in the concentration of 10 mg/l. After the flocculation stage with the anionic flocculent, the wastewater was treated by cationic flocculant based on poly acryl amide in the the concentration of 20 mg/l. Then, the wastewater was treated by 35 mass % solution of hydrogen peroxide in the concentration of 10 ml/l.

Thereafter, the formed sludge is separated from the water by magnetic field (in a magnetic separator). As a result of the treatment, the sludge volume achieved 3 volume % of the treated wastewater volume.

Further, the water, obtained after the separation from the sludge, was treated by 35 mass % hydrogen peroxide solution in the concentration of 40 ml/l. After the treatment, the water was passed through a column filled with a catalyst, e.g., ion exchange non-woven material (weak anion) in neutral form. The contact time between water and the neutral catalyst was 20 min.

The parameters of the wastewater before and after the treatment are presented in Table 1.

TABLE 1

| No | Item | Inlet water, mg/l | Outlet water, mg/l |
|---|---|---|---|
| 1 | COD | 6,100 | 180 |
| 2 | Phenol | 84 | 0.002 |
| 3 | Formaldehyde | 9.2 | 2.8 |
| 4 | Oil products | 9.2 | 0.1 |
| 5 | Detergents | 53 | 0.5 |
| 6 | Sulfides | 12.5 | 0.04 |
| 7 | Sulfates | 230 | 220 |
| 8 | Chlorides | 2,800 | 1,300 |
| 9 | Dry residue | 12,000 | 4,000 |
| 10 | General chromium | 2.5 | 0.02 |
| 11 | Cadmium | 0.008 | 0.005 |

### Example 2

The wastewater from Example 1, firstly, was treated as described in Example 1. Thereafter, the water additionally passed through a column filled with the same catalyst, however in its basic form. The catalyst was converted from the neutral form to the basic form by preliminary washing in water with 5 mass % solution of caustic soda. The contact time of the treated water with the catalyst was 15 min. At the outlet from the column with the basic catalyst the water exposed the parameters presented in Table 2.

TABLE 2

| | | Water after the | Outlet water |
|---|---|---|---|
| | | treatment as in | after further treatment |
| No | Item | Table 1, mg/l | with basic catalyst, mg/l |
| 1 | COD | 180 | 40 |
| 2 | Phenol | 0.002 | 0.001 |
| 3 | Formaldehyde | 2.8 | 0.07 |
| 4 | Oil products | 0.1 | 0.05 |
| 5 | Detergents | 0.5 | <0.1 |
| 6 | Sulfides | 0.04 | 0.004 |
| 7 | Sulfates | 220 | 100 |
| 8 | Chlorides | 1,300 | 600 |
| 9 | Dry residue | 4,000 | 2,500 |
| 10 | General chromium | 0.02 | 0.01 |
| 11 | Cadmium | 0.005 | 0.004 |

### Example 3

The wastewater from Examples 1 was treated mainly in the sane way as described in Example 12 with the only difference that ozone was used as the oxidizer instead of hydrogen peroxide. The quantity of ozone used in the treatment was 10 mg per liter of the wastewater. As a result, at the exit from the column with the basic catalyst, the COD had the value of 45 mg/l. For comparison, the direct treatment of the same wastewater with only ozone in the amount of 100 mg per liter of the wastewater reduced COD to 53 mg/l.

### Example 4

Wastewater with high content of the oil products and other organic impurities (see Table 3 for the initial parameters) was firstly treated by adding cation poly acryl amide based flocculant with high cation capacity in the amount of 20 mg/l, and then by adding anion poly acryl amide based flocculant in the amount of 20 mg/l.

After the de-emulsifying, a mechanical scrubber separated the floated oil products from the wastewater. The oil products were dried over 5 hours, and then used as a fuel in the process of evaporation of liquid technological waste containing more than 50 mass % of organic contaminants (mainly, oil products).

Thereafter, the wastewater was treated in accordance with the method of the present invention, as described above in Examples 1 with the following differences. The pH in the wastewater was adjusted first by basic coagulant (e.g., calcium hypo chlorite) to 9, and then, after the primary coagulation stage, the pH in the wastewater was adjusted by acidic coagulant (e.g., aluminum sulfate) to pH=6. The parameters of the wastewater before and after the treatment are presented in Table 3.

TABLE 3

| No. | Item | Inlet water, mg/l | Outlet water, mg/l |
|---|---|---|---|
| 1 | COD | 28 000 | 180 |
| 2 | Phenol | 110 | 0.002 |
| 3 | Formaldehyde | 13 | 0.5 |
| 4 | Oil products | 400 | 0.2 |
| 5 | Detergents | 280 | 0.7 |
| 6 | Sulfides | 10 | 0.005 |
| 7 | Sulfates | 250 | 120 |
| 8 | Chlorides | 3,000 | 1,500 |
| 9 | Dry residue | 12,000 | 3,000 |
| 10 | Total chromium | 2.0 | 0.03 |
| 11 | Cadmium | 0.01 | 0.005 |

### Example 5

Wastewater of a PCB plant having the pH of 4.3 and comprising the following impurities:

Copper in the amount of 12 mg/l;

Lead in the amount of 5.5 mg/l;

Manganese in the amount of 0.25 mg/l; and

Boron in the amount of 9.4 mg/l

was treated by a mixture of lime milk and suspended zinc ferrite. The zinc ferrite dose was only 5 mass % of the mass dose of the lime milk. Further, cationic poly acryl amide based flocculant was added with the dose of 1.2 mg/l. After the flocculation stage with the cationic flocculant, the wastewater was treated anion poly acryl amide based flocculant with the dose of 1.2 mg/l.

The formed sludge was separated by magnetic separation. Then, 25 mass % of the sludge was returned to the sludge formation zone.

After the separation of the sludge, the water was passed through a column filled with fiber ion-exchange material.

The water after the treatment exhibited the following results:

| pH | 7.6 | |
|---|---|---|
| Copper | 0.03 | mg/l |
| Lead | 0.13 | mg/l |
| Manganese | 0.01 | mg/l |
| Boron | 2.0 | mg/l |

By comparison, the consumption of the polymer flocculant in a conventional wastewater treatment process, comprising successive treatment of the wastewater by lime milk and polymer flocculant resulting in similar quality of the treated water, is 16 mg/l. Hence, using the method of the present invention can reduce consumption of the polymer flocculants by 6.7 times, as compared to the conventional technology. Moreover, the sludge sedimentation rate (by using the magnetic field of 100 Oe) can be increased by three-fold, while the sludge volume can be reduced by two times.

### Example 6

The wastewater of the PCB plant of Example 5 having the pH of 9.8 and comprising the following impurities:

Copper in the amount of 8 mg/l;

Lead in the amount of 5.5 mg/l;

Manganese in the amount of 0.25 mg/l; and

Boron in the amount of 9.4 mg/l

was treated by a mixture of lime milk and suspended zinc ferrite. The change of the parameters of the inlet wastewater from those in Example 6 was due to occasional discharge of a technological solution with different content into the general effluent. The treatment of the wastewater of Example 6 differs from treatment of Example 5 by the fact that an elevated dose of the magnetic reagent was added, set to 30 mass % of the lime milk mass. The fraction of recycled sludge (recycling coefficient) utilized in the treatment process had the value of 10 mass %.

The water after the treatment exhibited the following results:

| | |
|---|---|
| pH | 8.2; |
| Copper | 0.02 mg/l. |

Compared to the conventional technology, the total consumption of the polymer flocculant was reduced by four-fold, sludge deposition rate (in magnetic field of 100 Oe) was by four times higher, the sludge volume was reduced by 1.5 times.

### Example 7

Wastewater from detergent production having the following parameters:

| pH | 9.8; | |
|---|---|---|
| COD | 12,000 | mg/l; and |
| Anion detergents | 950 | mg/l |

was treated in accordance with the method of the invention.

First, zinc ferrite powder was introduced into the wastewater. Then, lime was used as basic coagulant for adjusting the pH to the value of 14. The zinc ferrite fraction was set to 20 mass % of the total amount of the lime mass. Sodium hypo chlorite was added to the wastewater, as an oxidizer, in the amount of 150 mg/l.

Thereafter, the wastewater was treated by acidic coagulant (e.g., aluminum sulfate) for adjusting the pH to the value of 9.

Further, an anionic flocculant was added based on poly acryl amide in the concentration of 10 mg/l. After the flocculation stage with the anionic flocculant, the wastewater was treated by cationic flocculant based on poly acryl amide in the concentration of 20 mg/l. Then, the wastewater was treated by 35 mass % solution of hydrogen peroxide in the concentration of 2 ml/l.

After separation of the sludge from the wastewater by means of a magnetic separator, the water was passed through a catalytic oxidation column. The sludge volume was 3 volume % of the volume of the treated water.

The water after the treatment exhibited the following results:

| pH | 6.9; | |
|---|---|---|
| COD | 300 | mg/l; |
| Anion detergents | 1-2 | mg/l. |

### Example 8

Wastewater from detergent production was treated as in Example 7 with the difference that the amount of 20 mass % of the sludge was returned to the coagulation zone before further adding the magnetic reagent and coagulants. As a result of such treatment, the volume of the removed sludge was 2 volume % of the treated water volume compared to the amount of 3 volume %, obtained in the process of Example 7, i.e., without partial recycling of the sludge. In this case, the consumption of coagulants was reduced by 15 mass %, compared to Example 7. In turn, the flocculant consumption was reduced by 8 mass %.

The water after the treatment exhibited the following results:

| pH = | 7.5; | |
|---|---|---|
| COD = | 320 | mg/l; |
| Anion detergents | 1 | mg/l. |

### Example 9

Wastewater from detergent production having the following parameters:

| pH | 9.8; | |
|---|---|---|
| COD | 7,000 | mg/l; |
| Anion detergents | 550 | mg/l |

was treated in accordance with the method of the invention, as in Example 6, with the difference in that the fraction of the recycled magnetic sludge was 50 mass %.

In this case, the volume of the removed sludge was 1 volume % of the treated water volume, compared to 4 volume % obtained by the process without the recycling of the sludge. The consumption of the magnetic reagent was reduced by 34 mass % and the flocculant consumption by 15 mass %, compared with the process without sludge recycling, as in Example 7.

The water parameters after the treatment were as follows:

| pH | 7.5; | |
|---|---|---|
| COD | 280 | mg/l; |
| Anion detergents | 1 | mg/l. |

### Example 10

Wastewater from detergent production having the following parameters:

| | |
|---|---|
| pH | 9.8; |
| COD | 18,000 mg/l; and |
| Anion detergents | 1,600 mg/l |

was treated in accordance with the method of the invention, as in example 5, with the difference in that the fraction of the recycled magnetic sludge was 10 mass %.

The volume of the formed sludge was 4.5 volume %, compared to the amount of 6 volume %, obtained in the same process carried out without sludge recycling.

The resulting parameters of the water were as follows:

| | |
|---|---|
| pH | 7.3; |
| COD | 350 mg/l; |
| Anion detergents | 3 mg/l. |

As such, those skilled in the art to which the present invention pertains, can appreciate that while the present invention has been described in terms of preferred embodiments, the concept upon which this disclosure is based may readily be utilized as a basis for the designing of other structures, systems and processes for carrying out the several purposes of the present invention.

Although the adjusting of the pH of the wastewater is described above by the treatment first with a basic coagulant and thereafter with ionic coagulant, it should be understood that depending on the requirements of the treatment, the adjusting of the pH of the wastewater can be started, mutatis mutandis, from introducing an acidic coagulant or carried out by only one coagulant, either basic or ionic.

In the method claims that follow, alphabetic characters used to designate claim steps are provided for convenience only and do not imply any particular order of performing the steps.

Also, it is to be understood that the phraseology and terminology employed herein are for the purpose of description and should not be regarded as limiting.

Finally, it should be noted that the word “comprising” as used throughout the appended claims is to be interpreted to mean “including but not limited to”.

It is important, therefore, that the scope of the invention is not construed as is being limited by the illustrative embodiments set forth herein. Other variations are possible within the scope of the present invention as defined in the appended claims and their equivalents.

1. A method for treating industrial wastewater, comprising:
(a) introducing powder of a ferromagnetic particulate material into the wastewater in an amount effective to provide magnetic susceptibility to sludge;
(b) adjusting a value of a pH of the wastewater by adding basic coagulant, thereby elevating the value of the pH of the wastewater to a first predetermined value of the pH;
(c) adjusting a value of a pH of the wastewater by adding acidic coagulant, thereby decreasing the value of the pH of the wastewater to a second predetermined value of the pH;
(d) oxidizing the wastewater having an adjusted value of the pH;
(e) flocculating the wastewater by adding at least one flocculant agent selected from cationic flocculant and anionic flocculant, to form flakes of the magnetic sludge in water; and
(f) separating the magnetic sludge from the water.

2. The method of claim 1 wherein the wastewater includes at least one component selected from heavy metals, oil products, detergents, phenols, dyes, complexions, and complexionates.

3. The method of claim 1 wherein particle size of said ferromagnetic particulate material is in the range of about 1 to 100 microns.

4. The method of claim 1 wherein of said ferromagnetic particulate material is made of ferrites of heavy metals.

5. The method of claim 4 wherein the ferrites include at least one element selected from zinc ferrite, magnetite (Fe₃O₄), gamma-hematite (gamma-Fe₂O₃), Barium ferrite (BaFe₂O₄).

6. The method of claim 1 wherein the amount of said ferromagnetic particulate material introduced into the wastewater is in the range of about 5 to 30 mass % of the entire amount of inorganic coagulants introduced into the wastewater.

7. The method of claim 1 wherein said first predetermined value of the pH of the wastewater is in the range of about 9 to 14.

8. The method of claim 1 wherein the powder of ferromagnetic particulate material is introduced before the basic coagulant.

9. The method of claim 1 wherein the powder of ferromagnetic particulate material is introduced after the basic coagulant.

10. The method of claim 1 wherein the powder of ferromagnetic particulate material is introduced simultaneously with the basic coagulant.

11. The method of claim 7 wherein the oxidizing of the wastewater is carried out by adding a first oxidizer being efficient at high pH.

12. The method of claim 11 wherein the first oxidizer is sodium hypo chlorite.

13. The method of claim 1 wherein said second predetermined value of the pH of the wastewater is in the range of about 6 to 9.

14. The method of claim 1 wherein the acidic coagulant is introduced after the basic coagulant.

15. The method of claim 1 wherein the acidic coagulant is a salt of iron or aluminum.

16. The method of claim 1 wherein the oxidizing of the wastewater is carried out by adding a second oxidizer being efficient at low pH.

17. The method of claim 16 wherein the second oxidizer is selected from hydrogen peroxide and ozone.

18. The method of claim 16 wherein the oxidizing of the wastewater with the second oxidizer is carried out after the flocculating of the waste water.

19. The method of claim 16 wherein the oxidizing of the wastewater with the second oxidizer is carried out before the flocculating of the wastewater.

20. The method of claim 16 wherein the oxidizing of the wastewater with the second oxidizer is carried out before and after the flocculating of the wastewater.

21. The method of claim 1 wherein the separating of the magnetic sludge from the water is carried out by applying a magnetic filed across an effluent of the wastewater after the flocculating.

22. The method of claim 21 wherein a linear velocity of an effluent flow is greater than 100 m/hour, the sludge has the floccules lesser than 10 mm in size, and a strength of the magnetic filed is greater than 0.1 Tesla.

23. The method of claim 1 further comprising the step of dewatering the sludge.

24. The method of claim 10 further comprising the step of packaging and storing the sludge.

25. The method of claim 1 further comprising the step of recycling a portion of the magnetic sludge, to use the sludge as magnetic reagent.

26. The method of claim 25 wherein the fraction of the recycled sludge is in the range of about 10 mass % to 50 mass % of a total sludge mass.

27. The method of claim 1 further comprising the step of discharging the water separated from the sludge into a sewage network.

28. The method of claim 1 further comprising the step of returning the water separated from the sludge to a technological process.

29. The method of claim 1 further comprising the step of passing the water separating from the sludge through a layer of catalyst in the form of an ion-exchange fiber material.

30. The method of claim 29 wherein the water separated from the sludge is first passed through an ion-exchange catalyst, being in its neutral form, and thereafter is passed through the ion-exchange catalyst, being in its basic form, thereby to provide more complete removal of the intermediate products of the organic substance oxidation destruction.

31. A system for treating industrial wastewater, comprising:
a static mixer configured for continuous mixing the wastewater supplied thereto with desired reagents;
a feeder of a magnetic powder configured for providing a ferromagnetic particulate material to said static mixer;
a coagulator apparatus coupled to said static mixer, and configured for preparation of a basic coagulation agent and supplying hereof to said static mixer;
a coagulator apparatus coupled to said static mixer, and configured for preparation of a acidic coagulation agent and supplying thereof to said static mixer;
at least one oxidizer apparatus coupled to said static mixer and configured for supplying an oxidizer thereto;
at least one flocculant apparatus coupled to said static mixer and configured for supplying at least one flocculant agent thereto selected from cationic flocculant and anionic flocculant, thereby to form flakes of the magnetic sludge in water; and
a magnetic separator configured for receiving the wastewater flowing downwardly from said static mixer and configured for applying a magnetic field across an effluent of the wastewater, thereby to separate the magnetic sludge from the water.

32. The system of claim 31 comprising a sludge suspension container downstream of said magnetic separator.

33. The system of claim 32 comprising a dryer downstream of said sludge suspension container and communicating with the static mixer for partial returning the magnetic sludge thereto.

34. The system of claim 31 comprising a first circulation pump for supplying the wastewater to said static mixer.

35. The system of claim 33 comprising a second circulation pump for supplying the magnetic sludge to said static mixer.

36. The system of claim 31 comprising a control unit configured for providing a control of the system.

37. The system of claim 31 comprising at least one sensor configured for generation a signal indicating at least a pressure or flow level.

38. The system of claim 31 comprising at least one water quality sensor adapted to indicate a water quality.

39. The system of claim 31 comprising at least one control valve adapted for regulating a wastewater flow.

40. The system of claim 31 comprising at least one reagent supply valve.
